(19) United States
(12) Patent Application Publication
(10) Pub. No.: US 2026/0242260 A1
(43) Pub. Date: Aug. 20, 2026

(54) MODULABLE METHOD FOR TREATING AN AQUEOUS EFFLUENT

(71) Applicant: SNF GROUP, ANDRÉZIEUX-BOUTHÉON (FR)

(72) Inventors: Frédéric BLONDEL, ANDRÉZIEUX-BOUTHÉON (FR); Mark NIEDERHAUSER, ANDRÉZIEUX-BOUTHÉON (FR); Morgan TIZZOTTI, ANDRÉZIEUX-BOUTHÉON (FR)

(73) Assignee: SNF GROUP, ANDRÉZIEUX-BOUTHÉON (FR)

(21) Appl. No.: 19/164,646

(22) PCT Filed: Mar. 13, 2024
(86) PCT No.: PCT/EP2024/056735

§ 371 Date: Sep. 12, 2025

(30) Foreign Application Priority Data
Mar. 13, 2023 (CA) 3192854

(51) Int. Cl. C02F 1/56; C02F 103/10

(52) U.S. Cl. CPC C02F 1/56; C02F 2103/10

(57) ABSTRACT

A modulable method for treating an aqueous effluent including a mechanical treatment, voluntary and controlled, of an aqueous solution (S) of water-soluble polymer (P) to obtain n aqueous solutions (S′_{[1, . . . , n]}), respectively including at least one polymer (P′_{[1, . . . , n]}) resulting from the shearing of the water-soluble polymer (P), and addition of an appropriate combination of the solutions (S) and (S′_{[1, . . . , n]}) to the effluent to be treated.

### FIELD

The invention relates to a modulable method for treating an aqueous effluent. Said method comprises a mechanical treatment, voluntary and controlled, of an aqueous solution (S) of water-soluble polymer (P) to obtain n aqueous solutions (S′_{[1, . . . , n]}), respectively comprising at least one polymer (P′[1, . . . , n]) resulting from the shearing of the water-soluble polymer (P). An appropriate combination of the solutions (S) and (S′_{[1, . . . , n]}) is added to the effluent to be treated.

### BACKGROUND

The use of polymer flocculant is widespread in the treatment of aqueous effluents such as mining effluents and wastewater, whether municipal or industrial. As those skilled in the art are aware, optimum performance during flocculation requires careful selection of the polymer flocculant upstream of the treatment, in other words determination of the optimum macromolecular parameters such as the molar mass, the chemical composition and the charge carried by said polymer flocculant.

However, in some cases, at the same treatment site, the effluents to be treated may differ over time in terms of composition, mineralogy, quantity of solids or particle size. At some sites, up to seven different effluents are found. This variability leads to problems as regards reproducibility in the efficiency of the treatment with flocculant. One way to overcome this problem is to dilute the effluent to maintain specific water/effluent tailing ratios. Another option is to use a mixture of several flocculants.

Document CA 364 854 A1 discloses a mixture of two anionic polymers with the same composition but with two different molecular weights for the dehydration of tailings.

This approach is also disclosed in documents WO2012/088291A1 and WO2015/173728 A1.

However, these mixtures are not ideal in terms of efficiency, cost and logistics. To be specific, at this type of treatment site, in other words sites with a great variability of tailings in the effluent, a combination of different polymers may be optimum at an instant t, but a drop in efficiency may be observed a few days later. It is thus easy to imagine the problems that operators have, on site, to adapt a treatment to ensure optimum efficiency.

The present application proposes to overcome this problem by disclosing a modulable method for treating aqueous effluent requiring a single starting polymer.

By applying different shear rates to the polymer, different molecular weights are obtained. It is thus possible to select this macromolecular parameter such that it is optimal in relation to the variations in composition and nature of the effluent to be treated to always have the best treatment possible, without the need to change the nature of the polymer used or the facilities.

Thus, according to the present application, it is possible to choose the desired effect as a function of the polymer selected. Depending on the sector of activity, the premises and local regulations, industrial needs vary, some seeking water without turbidity while others seek better floc strength or better compacting of the sludge. These properties are in particular linked to the molecular weight of the polymer used; with the method of the invention, it is thus possible to modulate the molecular weight of the polymers to obtain the desired properties.

### SUMMARY

The present invention relates to a method for treating an aqueous effluent comprising the following steps:
a) Preparing an aqueous solution (S) comprising at least one water-soluble polymer (P);
b) Mechanical treatment of the solution (S) to form n solutions (S′_{[1, . . . , n]}) respectively comprising at least one water-soluble polymer (P′_{[1, . . . , n]}) resulting from the mechanical treatment of the water-soluble polymer (P);
c) Adding to an aqueous effluent:
   c1) either at least two of the n solutions (S′_{[1, . . . , n]}), with n being an integer greater than or equal to 2,
   c2) or at least one of the n solutions (S′_{[1, . . . , n]}) and the solution (S), with n being an integer greater than or equal to 1.

In step c), the solutions (S′_{[1, . . . , n]}) and/or (S) may be added to the aqueous effluent separately and independently of one another, or are mixed beforehand prior to being added to the aqueous effluent.

### BRIEF DESCRIPTION OF THE FIGURES

FIG. 1 is a graphical depiction of an embodiment of the method of the invention in which part of the solution of water-soluble polymer (P) circulates in a first shearing apparatus, and another part of the solution of water-soluble polymer (P) circulates in a second shearing apparatus, having a shearing force lower than the first apparatus.

FIG. 2 is a graphical depiction of an embodiment of the method of the invention in which part of the solution of water-soluble polymer (P) circulates in two shearing apparatus in series, and another part of the solution of water-soluble polymer (P) circulates in a single shearing apparatus.

FIG. 3 is a graphical depiction of an embodiment of the method of the invention in which part of the solution of water-soluble polymer (P) passes through a shearing apparatus with a recirculation system, and another part of the solution of water-soluble polymer (P) circulates in another shearing apparatus without recirculation.

FIG. 4 is a graphical depiction of an embodiment of the method of the invention in which part of the solution of water-soluble polymer (P) circulates in a first shearing apparatus, and another part of the solution of water-soluble polymer (P) circulates in a second shearing apparatus having a shearing force lower than the first apparatus, and in which the aqueous solutions (S′₁) and (S′₂) are added to the aqueous effluent separately and independently of one another,

FIG. 5 is a graph depicting the evolution of the viscosity as a function of shearing for solutions of water-soluble polymer at 0.45% by weight and for successive shearings at 60 bar.

FIG. 6 is a graph showing the evolution of the rates of sedimentation as a function of the dosage of polymer in an effluent 1 for, on the one hand, a non-sheared solution of polymer, and on the other hand six solutions of polymers obtained by successive shearing.

FIG. 7 is a graph showing the evolution of the clarity of the supernatant as a function of the dosage of polymer in an effluent 1 for, on the one hand, a non-sheared solution of polymer, and on the other hand six solutions of polymers obtained by successive mechanical degradation.

FIG. 8 is a graph showing the evolution of the rates of sedimentation as a function of the dosage of polymer in an effluent 1 at t=0 month, for a solution of polymer sheared once at 60 bars, a solution of polymer sheared five times at 60 bar (Fraction 5), and for three mixtures with ratios different to the two previous solutions.

FIG. 9 is a graph showing the evolution of the clarity of the supernatant as a function of the dosage of polymer in an effluent 1 at t=0 month, for a solution of polymer sheared once at 60 bars, a highly sheared solution of polymer (Fraction 5), and for three mixtures with ratios different to the two previous solutions.

FIG. 10 is a graph showing the evolution of the rates of sedimentation as a function of the dosage of polymer in an effluent 1 at t=2 months for, on the one hand, a non-sheared solution of polymer, and on the other hand six solutions of polymers obtained by successive mechanical degradation.

FIG. 11 is a graph showing the evolution of the clarity of the supernatant as a function of the dosage of polymer in an effluent 1 at t=2 months for, on the one hand, a non-sheared solution of polymer, and on the other hand six solutions of polymers obtained by successive mechanical degradation.

FIG. 12 is a graph showing the evolution of the rates of sedimentation as a function of the dosage of polymer in an effluent 1 at t=2 months, for a non-sheared solution of polymer, a highly sheared solution of polymer (Fraction 4), and for three mixtures with ratios different to the two previous solutions.

FIG. 13 is a graph showing the evolution of the clarity of the supernatant as a function of the dosage of polymer in an effluent 1 at t=2 months, for a non-sheared solution of polymer, a highly sheared solution of polymer (Fraction 4), and for three mixtures with ratios different to the two previous solutions.

### DETAILED DESCRIPTION

### Definition

Throughout the present application, the following definitions apply unless specifically stated otherwise.

The term “mechanical treatment” refers to the mechanical shearing applied to the polymer (P) present in the solution (S).

According to the invention, the aqueous effluent is an aqueous suspension of particles. It is advantageously an effluent obtained from mining, coming from coal mines, diamond mines, phosphate mines, metal mines such as aluminium, platinum, iron, gold, copper, silver, etc., mines. The aqueous effluent may also be an effluent obtained from mining of bituminous sand or oil sand.

Preferably, the aqueous effluent is an effluent obtained from mining of bituminous sand or oil sand. In addition to the solid particles, the effluent comprises water. It may comprise sand, clay and water, or sand, clay, water and residual bitumen.

The aqueous effluent treated according to the method of the invention may comprise various tailings. These tailings may be fresh tailings or fine tailings. Preferably, it is an aqueous effluent comprising mature fine tailings (MFT) or an aqueous effluent comprising fresh fine tailings (FFT), in particular it is an aqueous effluent comprising mature fine tailings (MFT), and more particularly it is an aqueous effluent comprising mature fine tailings (MFT) comprising a quantity of clays ranging between 5 and 70% by weight.

In general, the aqueous effluent obtained from mining of bituminous sand and treated according to the invention may also comprise residual bitumen. The residual bitumen is then present in low amounts, generally in amounts below 5% by weight of the aqueous effluent.

The aqueous effluent treated according to the method of the invention may also be obtained from municipal or industrial water.

All ranges are included and can be combined. Value ranges include the upper and lower limits. Thus, the value ranges “between 0.1 and 1.0” and “from 0.1 to 1” include the values 0.1 and 1.0. The number of significant digits does not constitute any limitation on the quantities stated, or any limitation on the accuracy of the data.

As used herein, the term “hydrophilic monomer” designates a monomer with an octanol-water partition coefficient (Kow) less than 1, determined at a temperature of 25° C. and with a pH of between 6 and 8.

The partition coefficient Kow is defined as follows:

$$Kow = \frac{[ monomer ] octanol}{[ monomer ] water}$$

where
[monomer]octanol=concentration at the solubility equilibrium of the monomer in g/L in n-octanol [monomer]water=concentration of the monomer at equilibrium in g/L in water.

According to the present invention, the weight average molecular weight of the synthetic polymers according to the invention is determined by measuring the intrinsic viscosity. The intrinsic viscosity may be measured by methods known to those skilled in the art and may notably be calculated from the values of reduced viscosity for different concentrations by a graphical method consisting in plotting the values of reduced viscosity (on the x-axis) as a function of the concentrations (on the y-axis) and extrapolating the curve to a zero concentration. The value of intrinsic viscosity is read on the x-axis or using the least squares method. The weight average molecular weight may then be determined by the Mark-Houwink equation:

$$[ η ] = K \cdot {M}^{α}$$

[η] represents the intrinsic viscosity of the polymer determined by the method of measuring the viscosity in solution,
K represents an empirical constant,
M represents the molecular weight of the polymer,
α represents the Mark-Houwink coefficient,
α and K depend on the particular polymer-solvent system. Tables known to those skilled in the art give the values of a and K according to the polymer-solvent system.

The term “polymer” designates a product formed by the polymerization of at least one monomer. Polymers prepared from a single type of monomer are called homopolymers, while polymers prepared from at least two different monomers are called copolymers.

As used herein, the term “water-soluble polymer” designates a polymer which produces an aqueous solution without insoluble particles when it is dissolved with stirring for 4 hours at 25° C. and with a concentration of 50 g·L⁻¹ in deionized water.

An “anionic polymer” means a polymer containing anionic monomers and optionally non-ionic monomers. A “non-ionic polymer” means a polymer containing only non-ionic monomers. A “cationic polymer” means a polymer containing cationic monomers and optionally non-ionic monomers. An “amphoteric polymer” means a polymer containing anionic monomers and cationic monomers and optionally at least one non-ionic and/or zwitterionic monomer.

### Method for Treating an Aqueous Effluent

As explained above, the invention relates to a method for treating an aqueous effluent comprising the following steps:
a) Preparing an aqueous solution (S) comprising at least one water-soluble polymer (P);
b) Mechanical treatment of the solution (S) to form n solutions (S′_{[1, . . . , n]}) respectively comprising at least one water-soluble polymer (P′_{[1, . . . , n]}) resulting from the mechanical treatment of the water-soluble polymer (P);
c) Adding to an aqueous effluent:
   c1) either at least two of the n solutions (S′_{[1, . . . , n]}), with n being an integer greater than or equal to 2,
   c2) or at least one of the n solutions (S′_{[1, . . . , n]}) and the solution (S), with n being an integer greater than or equal to 1.

In step c), the solutions (S′_{[1, . . . , n]}) and/or (S) may be added to the aqueous effluent separately and independently of one another, or are mixed beforehand prior to being added to the aqueous effluent.

In one preferred embodiment, step a) is preceded by a preliminary step consisting in performing flocculation tests, by taking at least one sample of the aqueous effluent to be treated, in order to determine the optimal combination of water-soluble polymers necessary for treating the aqueous effluent and the shear rates to be applied.

The various steps of the method are described in detail below.

### Step a) of Preparing an Aqueous Solution (S) Comprising at Least One Water-Soluble Polymer (P).

The solution (S) advantageously comprises between 0.1% and 5% by weight of water-soluble polymer (P) relative to the total weight of the solution (S), more preferably between 0.2% and 1% by weight of water-soluble polymer (P) relative to the total weight of the solution (S).

The solution (S) is prepared by dissolving a water-soluble polymer (P) in an aqueous medium, said aqueous medium preferably being water. The usual means for dissolving water-soluble polymers may be used, such as static mixers, stirring blades in a tank. Those skilled in the art will adapt these means and the dissolution conditions according to the knowledge in the field.

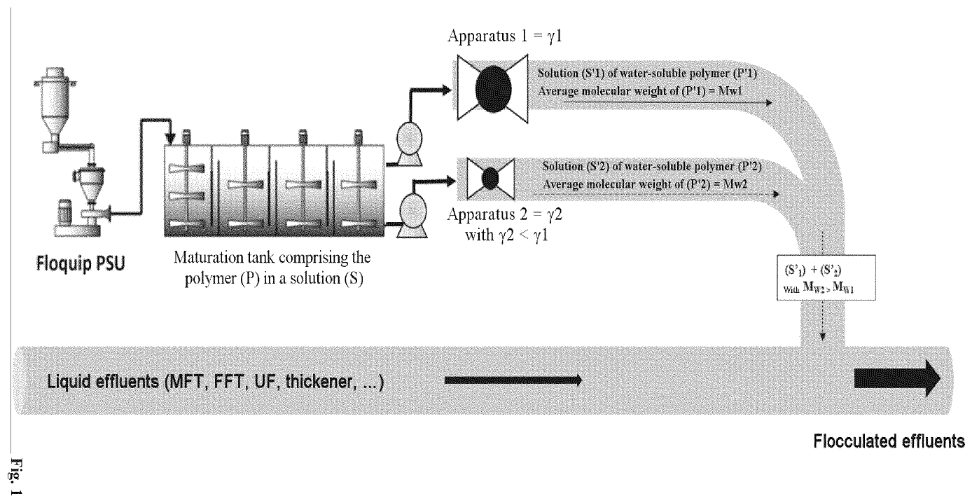

When the water-soluble polymer (P) is in powder form, the solution (S) of water-soluble polymer (P) is preferably produced using a device for hydration, preferably rapid, of the solid particles of water-soluble polymer (P), notably using a device such as a PSU (Polymer Slicing Unit), described in particular in application WO 2008/107492, then using one or more tanks for dissolution and for maturation with stirring. FIGS. 1 to 4 show this type of facility.

### The Water-Soluble Polymer (P)

The polymer (P) is a water-soluble polymer. It may be non-ionic, anionic, cationic or amphoteric. The polymer (P) is preferably a flocculant.

The water-soluble polymer (P) may be obtained by polymerization of at least one non-ionic monomer and/or of at least one anionic monomer and/or of at least one cationic monomer and/or of at least one zwitterionic monomer. Said monomers are preferably hydrophilic monomers, in other words monomers with a partition coefficient of below 1. Advantageously, these monomers have a single ethylene unsaturation (double bond between two carbon atoms).

The non-ionic hydrophilic monomers may be selected from the group comprising vinyl monomers which are soluble in water, such as acrylamide, methacrylamide, N-alkylacrylamides, N-alkylmethacrylamides, N,N-dialkyl acrylamides (for example N,N-dimethylacrylamide or N,N-diethylacrylamide), N,N-dialkyl methacrylamides, alkoxylated esters of acrylic acid, alkoxylated esters of methacrylic acid, N-vinylpyrrolidone, N-methylolacrylamide, N-vinylformamide (NVF), N-vinylacetamide, N-vinylimidazole, N-vinylsuccinimide, acryloyl morpholine (ACMO), acryloyl chloride, glycidyl methacrylate, glyceryl methacrylate, diacetone acrylamide, hydroxyalkyl (meth)acrylate, aminoalkyl (meth)acrylate, thioalkyl (meth)acrylate, hydroxyalkyl acrylates, hydroxyalkyl methacrylates, and mixtures thereof. Among these non-ionic hydrophilic monomers, the alkyl groups advantageously comprise chains of 1 to 5 carbons, more advantageously of 1 to 3 carbons.

According to one embodiment of the invention, the non-ionic hydrophilic monomers may be linear alkyls. Preferably, the non-ionic hydrophilic monomer is acrylamide.

Preferably, the water-soluble polymer (P) comprises non-ionic hydrophilic monomers in a quantity ranging from 5 to 95 mol %, more preferably from 20 to 80 mol %, even more preferably from 10 to 50 mol %, relative to the total number of moles of monomers.

The anionic hydrophilic monomers may be selected from a large group. These monomers may have vinyl, acrylic, maleic, fumaric, malonic, itaconic or allylic functions, and contain a carboxylate, phosphonate, phosphate, sulphate, sulphonate group, or another anionically charged group. Examples of anionic hydrophilic monomers include acrylic acid; methacrylic acid; dimethylacrylic acid; itaconic acid; crotonic acid; maleic acid; fumaric acid; acrylamido undecanoic acid; 3-acrylamido-3-methylbutanoic acid; maleic anhydride; strong acid type monomers having for example a sulphonic acid or phosphonic acid type function such as vinylsulphonic acid, vinylphosphonic acid, allylsulphonic acid, methallylsulphonic acid, 2-methylidenepropane-1,3-disulphonic acid, 2-sulphoethylmethacrylate, sulphopropylmethacrylate, sulphopropylacrylate, allylphosphonic acid, styrene sulphonic acid, 2-acrylamido-2-methylpropane sulphonic acid (ATBS), 2-acrylamido-2-methylpropane disulphonic acid; the water-soluble salts of these monomers such as their alkali metal salts (distinct from the crystalline form of the sodium salt of 2-acrylamido-2-methylpropane sulphonic acid), alkaline earth metals, or ammonium; and mixtures thereof. Preferably, the anionic hydrophilic monomer may be acrylic acid or 2-acrylamido-2-methylpropane sulphonic acid (ATBS) and/or salts thereof.

According to one aspect of the invention, at least some of the acid functions of the anionic monomer or monomers may be salified by a salification agent, also referred to as a neutralization agent. Salified means that at least one acid function of the anionic monomer is replaced by a salt neutralizing the negative charge of the acid function. In other words, the non-salified form corresponds to the acid form of the monomer, for example R—C(═O)—OH in the case of the carboxylic acid function, while the neutralized form of the monomer corresponds to the form R—C(═O)O⁻X⁺, X⁺ corresponding to an ion of positive charge. The neutralization of the acid functions may be partial or total.

Salification may take place faire before, during or after polymerization.

In one particular embodiment of the invention, between 30 to 100 mol % of the acid functions of the anionic monomers are salified, more advantageously between 60 and 100 mol %.

When the water-soluble polymer (P) is anionic, the anionicity is preferably between 1 and 90 mol %, preferably between 5 and 60 mol %, even more preferably between 10 and 50 mol %.

The cationic hydrophilic monomers may be selected from monomers derived from units of vinyl type, notably acrylamide, acrylic, allylic or maleic, these monomers having a quaternary ammonium or phosphonium function. Mention may be made, in particular and in a non-limiting manner, of quaternized dimethylaminoethyl acrylate (ADAME), quaternized dimethylaminoethyl methacrylate (MADAME), diallyldimethylammonium chloride (DADMAC), acrylamido propyl trimethyl ammonium chloride (APTAC), and methacrylamido propyl trimethyl ammonium chloride (MAPTAC). The quaternization agent may be chosen from alkyl chlorides, dialkyl sulphates or alkyl halides. Preferably, the quaternization agent is chosen from methyl chloride and diethyl sulphate.

Those skilled in the art will know how to prepare quaternized monomers, for example using alkyl halide of R*—X type, R* being an alkyl group (advantageously C1-C3) and X being a halide (R—X may be, in particular, methyl chloride). Furthermore, the present invention also covers monomers of DADMAC, APTAC and MAPTAC type in which the halide counter-ion is fluoride, bromide or iodide instead of chloride.

When the water-soluble polymer (P) is cationic, the cationicity is between 1 and 100 mol %, preferably between 5 and 90 mol %, even more preferably between 7 and 85 mol %.

The zwitterionic hydrophilic monomers, may be selected from a derivative of a unit of vinyl type, notably acrylamide, acrylic, allylic or maleic, this monomer having a quaternary ammonium or amine function and an acid function of carboxylic (or carboxylate), sulphonic (or sulphonate) or phosphoric (or phosphate) type. Mention may be made, in particular and in a non-limiting manner, of dimethylaminoethyl acrylate derivatives, such as 2-((2-(acryloyloxy)ethyl)dimethylammonio)ethane-1-sulphonate, 3-((2-(acryloyloxy)ethyl)dimethylammonio)propane-1-sulphonate, 4-((2-(acryloyloxy)ethyl)dimethylammonio)butane-1-sulphonate, [2-(acryloyloxy)ethyl](dimethylammonio)acetate, dimethylaminoethyl methacrylate derivatives such as 2-((2-(methacryloyloxy)ethyl)dimethylammonio)ethane-1-sulphonate, 3-((2-(methacryloyloxy)ethyl)dimethylammonio)propane-1-sulphonate, 4-((2-(methacryloyloxy)ethyl)dimethylammonio)butane-1-sulphonate, [2-(methacryloyloxy)ethyl](dimethylammonio)acetate, dimethylamino propylacrylamide derivatives such as 2-((3-acrylamidopropyl)dimethylammonio)ethane-1-sulphonate, 3-((3-acrylamidopropyl)dimethylammonio)propane-1-sulphonate, 4-((3-acrylamidopropyl)dimethylammonio)butane-1-sulphonate, [3-(acryloyloxy)propyl](dimethylammonio)acetate, dimethylaminopropyl methylacrylamide derivatives such as 2-((3-methacrylamidopropyl)dimethylammonio)ethane-1-sulphonate, 3-((3-methacrylamidopropyl)dimethylammonio)propane-1-sulphonate, 4-((3-methacrylamidopropyl)dimethylammonio)butane-1-sulphonate and [3-(methacryloyloxy)propyl](dimethylammonio)acetate and mixtures thereof.

Advantageously, the preferred hydrophilic monomers for the water-soluble polymer (P) are selected from acrylamide, acrylic acid, 2-acrylamido-2-methylpropanesulphonic acid and the corresponding salts thereof or mixtures thereof, N-vinylpyrrolidone (NVP), acrylamido propyl trimethyl ammonium chloride (APTAC), methacrylamido propyl trimethyl ammonium chloride (MAPTAC), quaternized dimethylaminoethyl acrylate (ADAME), quaternized dimethylaminoethyl methacrylate (MADAME), and diallyldimethylammonium chloride (DADMAC).

Advantageously, the water-soluble polymer (P) is obtained by radical polymerization.

In the present application, radical polymerization means conventional radical polymerization or controlled radical polymerization (CRP). This covers techniques such as Iodine Transfer Polymerization (ITP), Nitroxide Mediated Polymerization (NMP), Atom Transfer Radical Polymerization (ATRP), Reversible Addition Fragmentation chain Transfer Polymerization (RAFT), including MADIX (MAcromolecular Design by Interchange of Xanthates) technology.

According to one embodiment of the invention, the water-soluble polymer (P) is obtained by conventional radical polymerization.

The polymerization initiator may be selected from the initiators conventionally used in radical polymerization. Generally, polymerization is initiated using free radical initiators with one or more of the hydrophilic monomers. As examples of agents generating free radicals, mention may be made of oxidation-reduction couples with, among the oxidizing agents, cumene hydroperoxide or tertiary butyl hydroxy peroxide, and among the reducing agents, persulphates such as sodium metabisulphite and Mohr's salt. Azo compounds such as 2,2′-azobis(isobutyronitrile), 2,2′-azobis(2-methylbutyronitrile) and 2,2′-azobis(2-amidinopropane) hydrochloride may also be used in the same capacity as peroxide compounds such as benzoyl peroxide, tert-butyl hydroperoxide or lauroyl peroxide.

According to one aspect of the invention, the water-soluble polymer (P) may be post-hydrolysed. Post-hydrolysis is a reaction carried out on the polymer after polymerization. This step consists of the reaction of the hydrolysable functions of the monomers, advantageously non-ionic, more preferably of the amide or ester functions, with a hydrolysis agent. This hydrolysis agent may be an enzyme, an ion exchange resin, or an alkali metal. Preferably, the hydrolysis agent is a Bronsted base. During this post-hydrolysis, the number of carboxylic acid functions increases. To be specific, the reaction between the base and the amide or ester functions present in the water-soluble polymer (P) leads to the formation of carboxylate groups.

According to the invention, the water-soluble polymer (P) may have a linear, branched, star, comb structure or polydispersity controlled in molecular weight. These properties may be obtained by selection of the initiator, of the transfer agent, of the polymerization technique such as controlled radical polymerization as described above, the incorporation of monomers of structure, the concentration. Those skilled in the art will draw on their general knowledge to prepare a water-soluble polymer (P) having one of these types of structure. Whatever its morphology, the water-soluble polymer (P) is always soluble in water.

The water-soluble polymer (P) may be obtained and used in liquid form, in other words in solution (emulsion, aqueous solution) or in the form of particles (powder, microbeads, aqueous or oil dispersions, fine agglomerates). Advantageously, the water-soluble polymer (P) is used in powder form.

The powder form of the polymer (P) may be obtained by gel polymerization, by polymerization in aqueous solution followed by drum drying or spray drying or radiation drying such as microwave drying or drying in a fluidized bed.

The powder form of the water-soluble polymer (P) may also be obtained by polymerization in water-in-oil emulsion (invert emulsion), followed by a step of distillation/concentration and spray drying of the resulting liquid.

Polymer (P) microbeads may be obtained by polymerization in inverse suspension.

According to one embodiment of the invention, the polymer (P) is in the form of a powder obtained by the gel route or by “spray drying” from an invert emulsion.

The weight average molecular weight of the water-soluble polymer (P) is advantageously between 3 million daltons and 30 million daltons, more preferably between 5 million and 30 million daltons. By having the highest possible molecular weight, it is possible to cover a broad range of molecular weights to be attained by virtue of shearing.

According to a preferred embodiment of the invention, the water-soluble polymer (P) has a UL viscosity of between 3 and 9 cP, even more preferably between 5 and 7 cP.

The UL viscosity is measured using a Brookfield viscosimeter of LVT type equipped with a UL adapter the module of which rotates at 60 rpm (0.1% polymer by weight in a saline solution of 1M sodium chloride at 25° C.).

In one particular embodiment according to the invention, when the water-soluble polymer (P) is anionic, the solution (S) may comprise salts in order to facilitate the step of shearing of said polymer (P).

The salts used may be inorganic and/or organic, preferably the salts used are inorganic salts.

The salts used may be monovalent, divalent or trivalent, preferably the salts used are divalent.

Advantageously, the salts used are alkali metal salts and/or alkaline earth metal salts, advantageously the salts used are alkaline earth metal salts.

Advantageously, an alkaline earth metal salt such as calcium Ca²⁺ and/or magnesium Mg²⁺, facilitates the degradation of the anionic polymers as a whole.

Advantageously, the counter-ion of the salt or salts used is selected from hydroxide ions, halide (preferably chloride) ions, sulphate ions, formate ions, acetate ions, carbonate ions and mixtures thereof.

The weight ratio between the salt and the water-soluble polymer (P) is advantageously between 10 and 90% by weight, more preferably between 20 and 70% by weight, more preferably between 30 and 50% by weight relative to the total weight of the solution (S); this quantity of salt added to the solution (S) does not take into account the counter-ions used to salify the water-soluble polymer (P). At least some of the salt used in the invention may already be present in the effluent to be treated, the rest being added during the preparation of the solution (S).

Step b) of Mechanical Treatment of the Solution (S) to Form n Solutions (S′_{[1, . . . , n]}) Respectively Comprising at Least One Water-Soluble Polymer (P′_{[1, . . . , n]}) Resulting from the Mechanical Treatment of the Water-Soluble Polymer (P).

This step b) of the method may be carried out according to two embodiments.

The first embodiment consists in first separating the solution (S) of water-soluble polymer (P) into at least two fractions, then shearing the polymer of said fractions, and the second embodiment consists in first shearing the water-soluble polymer (P) of the solution (S), then removing part thereof, and repeating the shearing and removal operation to obtain several increasingly sheared polymer solutions.

According to a first embodiment of the method of the invention, step b) is characterized in that the mechanical treatment of the solution (S) comprises the following successive steps:
b1) separation of the solution (S) into n solutions (S_{[1, . . . , n]}), then
b2) shearing of the n solutions (S_{[1, . . . , n]}), in which the n solutions (S_{[1, . . . , n]}) are sheared independently of one another, to form n solutions (S′_{[1, . . . , n]}) respectively comprising at least one water-soluble polymer (P′_{[1, . . . , n]}).

In this first embodiment, the solution (S) of water-soluble polymer (P) is first of all separated into several fractions. It is possible to keep part of the solution (S) without submitting it to shearing. Each fraction is sheared independently of one another at different shear rates for each of the fractions.

A solution (S′₁) of water-soluble polymer (P′₁) is thus obtained, the addition of the “prime” meaning that the solution (S) comprising the polymer (P) has been sheared at least once, with the subscript number increasing as shearing progresses. As the water-soluble polymer (P′₁) has been sheared, its molecular weight is lower than the molecular weight of the water-soluble polymer (P).

According to this first embodiment, a solution (S′₁) of water-soluble polymer (P′₁), a solution (S′₂) of water-soluble polymer (P′₂), a solution (S′₃) of water-soluble polymer (P′₃), a solution (S′₄) of water-soluble polymer (P′₄), etc. may thus be obtained.

According to a second embodiment of the method of the invention, step b) is characterized in that it comprises the following successive steps:
b1′) shearing of the solution (S), to form a solution (S′_{[1, . . . , n]}) respectively comprising at least one water-soluble polymer (P′_{[1, . . . , n]}), then
b2′) removing at least part of the solution (S′_{[1, . . . , n]}), then if n is an integer greater than or equal to 2,
b3′) repeating, as many times as necessary, successive steps consisting in shearing the remainder, then in removing at least part thereof, to respectively obtain the solutions (S′_{[2, . . . , n]}).

In this second embodiment, the solution (S) of water-soluble polymer (P) is first of all sheared to obtain a solution (S′₁) of water-soluble polymer (P′₁). It is possible of keep part of the solution (S) without submitting it to shearing. It is also possible not to carry out any additional shearing operation, in which case the result is a solution (S) of water-soluble polymer (P), and a solution (S′₁) of water-soluble polymer (P′₁).

Generally, the method will proceed by removing at least part of the solution (S′₁), then shearing the remainder to obtain a solution (S′₂) of water-soluble polymer (P′₂). The shear rate applied may be identical or different in each step of shearing. The shearing operation may be repeated on the remainder to obtain a solution (S′₃) of water-soluble polymer (P′₃), and so on, removing at least part of the solution sheared prior to starting another step of shearing.

According to this second embodiment, a solution (S′₁) of water-soluble polymer (P′₁), a solution (S′₂) of water-soluble polymer (P′₂), a solution (S′₃) of water-soluble polymer (P′₃), a solution (S′₄) of water-soluble polymer (P′₄), etc. may thus be obtained.

In step b) of the method according to the invention, the shearing of the aqueous solutions (S) and (S′n) may be carried out in any way and using any shearing apparatus, preferably those making it possible to measure the shear rate applied to the water-soluble polymer.

Shearing may be carried out, in general, with the aid of any type of shearing apparatus, by way of non-limiting example with the aid of a pump (in-line or otherwise), by passage through a pipeline with a restricted passage or with the aid of a valve, preferably shearing is carried out with the aid of a pump, and even more preferably an in-line pump.

Generally, the shear rate of the apparatus on site is known to those skilled in the art. Thus, the appropriate shear rate to be applied is determined as a function of the properties of the polymers it is desired to obtain to treat the aqueous effluent. Those skilled in the art will be able to adjust this level and select the necessary apparatus, both of these being conventional choices, to obtain the right polymers.

In one particular embodiment of the invention according to FIG. 1, and corresponding to the first embodiment of step b), the solution (S) is separated into two fractions, then each of these fractions is sheared differently. The first fraction passes through a single pump for intensive shearing to obtain a solution (S′₁) of water-soluble polymer (P′₁), the second fraction passes through a pump for less intensive shearing to obtain a solution (S′₂) of water-soluble polymer (P′₂).

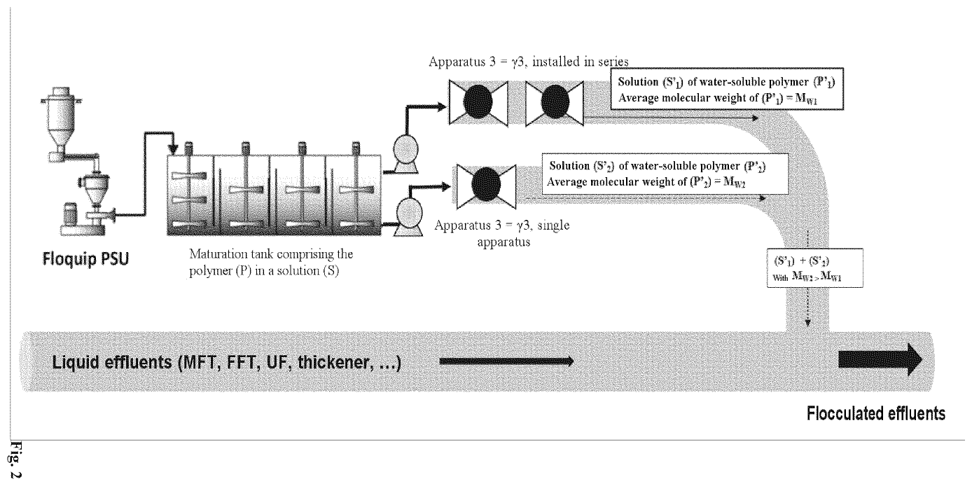

In another particular embodiment of the invention according to FIG. 2, the first fraction of the aqueous solution (S) circulates in at least two shearing apparatus installed in series, in order to subject the water-soluble polymer (P) present in the solution to sufficient shearing to attain the desired properties. A solution (S′₁) of water-soluble polymer (P′₁) is obtained. The second fraction circulates in a single shearing apparatus to obtain a solution (S′₂) of water-soluble polymer (P′₂).

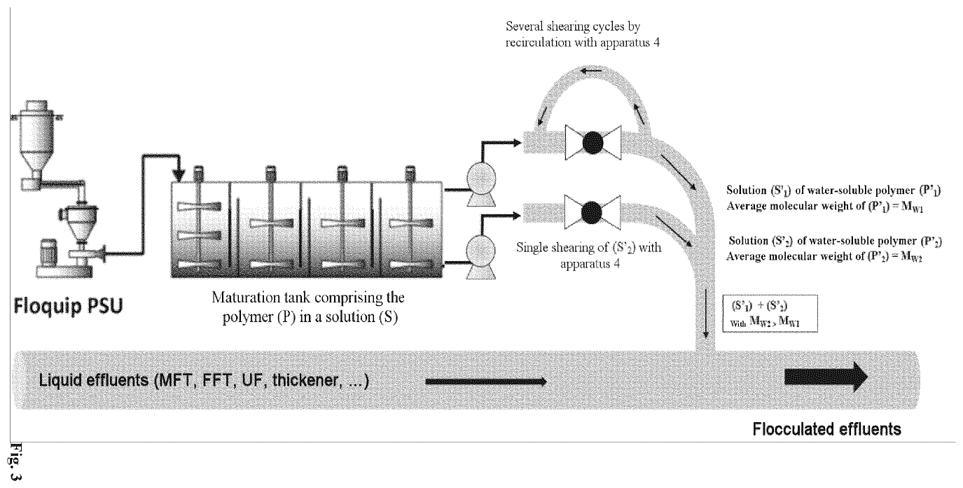

In another particular embodiment of the invention according to FIG. 3, several successive shearings may be applied to the first fraction of aqueous solution (S) by recirculating all or part of the sheared solution (S′₁) in the same shearing apparatus, in order to subject the water-soluble polymer (P) present in the solution to sufficient shearing to attain the desired properties. The second fraction circulates in a single shearing apparatus to obtain a solution (S′₂) of water-soluble polymer (P′₂).

In these particular embodiments, the molecular weight of the water-soluble polymer (P′₁) is thus lower than that of the water-soluble polymer (P′₂).

Thus, there is no lower limit as regards the shear rate, which depends on the specific properties of the polymer which are required. With a low-shearing apparatus, it is possible, as described above, to recirculate the solution comprising the polymer or to pass the solution through several apparatus in series. There is also no upper limit as regards the shear rate because this is limited by the technology currently available, and the higher the shear rate, the more the polymer will be degraded (broken down). Those skilled in the art will be able to adjust the power and the number of shearing apparatus to attain the desired polymer.

Each shearing apparatus may be controlled individually to make it possible to obtain as many water-soluble polymers (P′ₙ) as necessary, if two or more polymer fractions with different molecular weights are required.

A preferred example of a shearing apparatus is a shear pump consisting of a pressurized cell connected to a pipe of small diameter. The principle is to pass a liquid under pressure from a pipe of large section to a pipe of smaller section, this forced passage causing shearing, and making it possible to modify the water-soluble polymer by breaking some polymer chains, and thus reduce the molecular weight of the water-soluble polymer.

Those skilled in the art will be able to adjust the parameters, notably in terms of pressure, flow rate and section, to control the shearing to which the polymer of the invention is subjected, and thus obtain an optimum result.

The polymer solution is for example degraded (broken down) by shearing by passing the solution through a pipe having an inside diameter of 10.8 cm to a pipe having an inside diameter of 0.87 mm with a pressure drop set at 60 bar.

The shear rate is determined with the aid of the following formula:

$$γ = ( 4 \times Q ) / ( π \times {R}^{3} )$$

with γ: shear rate (s⁻¹)
Q: flow rate (g/s)
R: radius of the capillary (cm)

The shearing of the polymer (P) of the solution (S) is performed mechanically. The shear rate is in this case associated with a pressure applied.

The rheological profiles of the sheared solutions may be prepared with the aid, for example, of an MCR 302 Kinexus rheometer with cone-plate geometry at 2° and 60 mm at shear rates ranging from 1 to 100 s-1 and at 25° C.

The number n corresponds to the number of solutions of polymer obtained after mechanical treatment according to step b) of the method and to the number of polymers obtained after mechanical treatment according to step b). The number n is not limited and depends on the aqueous effluent to be treated. Generally, two solutions (S′₁) and (S′₂) are sufficient to obtain and select the combination of water-soluble polymers (P′₁) and (P′₂) necessary. However, the number n may be higher, for example 3, 4 or 5; it is preferably lower than 10. The number n is an integer preferably between 1 and 10, more preferably between 2 and 6.

Each aqueous solution (S′ₙ) comprises a corresponding water-soluble polymer (P′ₙ). For example, the aqueous solution (S′₁) comprises a water-soluble polymer (P′₁) resulting from the shearing of the solution (S) of water-soluble polymer (P).

The weight average molecular weight of the water-soluble polymer (P′ₙ) is advantageously greater than 500 000 daltons, more preferably greater than 750 000 daltons, even more preferably greater than 1 000 000 daltons.

Step c) of Addition to an Aqueous Effluent

The following step of the method according to the invention consists in adding the solutions of water-soluble polymers obtained in step b) to an aqueous effluent to be treated. The method of the invention makes it possible to obtain a combination of aqueous solutions of water-soluble polymers making it possible to modulate and improve the treatment of the aqueous effluent.

The aqueous solutions (S′ₙ) may be added to the aqueous effluent to be treated in a number of ways. In a first embodiment, the solutions may be added to the effluent to be treated separately and independently of one another. In a second embodiment, the solutions may be mixed beforehand prior to being added to the effluent to be treated.

Preferably, the aqueous solutions (S′ₙ) are mixed beforehand prior to being added to the aqueous effluent to be treated. The weight ratio between the various solutions (S′ₙ) may be adjusted in variable proportions which depend on the desired optimum result.

The mixture may be made up of at least two mechanically treated solutions. It may for example contain 25% by weight of the solution (S′₁) with 25% by weight of the solution (S′₂), and 50% by weight of the solution (S′₃).

The mixture may also be made up of a part not mechanically treated, in other words the solution (S), and of at least one solution (S′ₙ). It may for example contain 50% by weight of solution (S), 25% by weight of solution (S′₁), and 25% by weight of solution (S′₂).

Those skilled in the art will be able to adjust the ratios of the various solutions to obtain the desired optimum result. They can also vary these ratios over time as a function of the evolution of the characteristics of the effluent to be treated, such as for example its solids content.

Step c) of the method according to the invention is a step of adding to an aqueous effluent
c1) either at least two of the n solutions (S′_{[1, . . . , n]}), with n being an integer greater than or equal to 2,
c2) or at least one of the n solutions (S′_{[1, . . . , n]}), and the solution (S) with n being an integer greater than or equal to 1.

In step c), the solutions (S′_{[1, . . . , n]}) and/or (S) may be added to the aqueous effluent separately and independently of one another, or are mixed beforehand prior to being added to the aqueous effluent.

The average concentration of water-soluble polymer in the aqueous solutions (S) and (S′ₙ) added to the effluent to be treated relative to the quantity of effluent is preferably between 1 ppm and 15000 ppm, more preferably between 100 ppm and 7000 ppm, even more preferably 50 ppm and 5000 ppm. This concentration corresponds to the quantity of polymer (P) and (P′ₙ) added to the effluent.

On leaving the separation cell, the sludge is treated in two different ways; it is either sent to a holding pond where it is decanted, or it is treated directly in a thickener. The method according to the invention applies to these two ways of treating the sludge.

According to a first embodiment, the addition of the aqueous solutions (S) and (S′ₙ) or the mixture of solutions may be carried out in a thickener, which is a retention zone, generally in the form of a tube section with a diameter of several metres having a conical bottom in which the particles can sediment.

According to one specific embodiment, the aqueous effluent is conveyed by a pipe to a thickener, and the solution or solutions of polymers are added in said pipe.

According to a second embodiment, the aqueous solutions (S) and (S′ₙ) are added to the aqueous effluent while said effluent is being conveyed to a deposition zone (Under Flow treatment of the thickener or UF). Preferably, the aqueous solutions are added in the pipe which conveys said effluent to a deposition zone. It is in this deposition zone that the aqueous effluent is spread out with a view to dehydrating and solidifying same. The deposition zones may be open, for example a non-delimited stretch of ground, or closed, such as for example a pond or a cell.

According to a third embodiment, the aqueous solutions (S) and (S′n) are added by means of a pipe leading to a thickener and also while said aqueous effluent is being conveyed on leaving the thickener for a deposition zone.

The fraction at the bottom of the holding pond is highly concentrated in dry matter; this sludge is referred to as “Mature Fine Tailings” or MFT.

According to a fourth embodiment of the invention, the MFT are pumped and treated by flocculation. The injection of the aqueous solutions (S) and (S′n) takes place as they pass through the pipes, preferably prior to the step of filtration (belt filter, press filter or decanter centrifuge). The flocculated sludge is discharged in deposition zones referred to as a deposition cell, where it dries by atmospheric evaporation.

According to a fifth embodiment, the aqueous solutions (S) and (S′ₙ) are injected simultaneously according to embodiments 1 and 4, or according to embodiments 2 and 4, or 3 and 4.

### Preliminary Step of Flocculation Tests

According to a preferred embodiment of the invention, prior to carrying out step a) of the treatment method of the invention it may be possible to carry out flocculation tests, by taking at least one sample of the aqueous effluent to be treated, in order to determine: the combination of water-soluble polymers necessary to treat the aqueous effluent and the shear rates to be applied to achieve this combination.

Choosing the best flocculant treatment usually results in choosing the right flocculant.

Choosing the right flocculant depends on the composition and the nature of the aqueous effluent to be treated.

Those skilled in the art are familiar with the standard flocculation tests necessary to determine the choice of optimum polymers for treating the aqueous effluent to be treated, this being easy to implement in the field.
First, a sample of the aqueous effluent to be treated is taken.
Second, a polymer is selected, a minimum dosage of flocculant, an ionicity, a molecular weight.
Third, at least one flocculation test is carried out. Generally, the parameters of clarity and decantation are implemented (Jar Test). A first visual observation of the flocs is performed, to assess the incorporation of the polymer flocculant in the aqueous effluent to be treated. To this end, the decantation time, the strength and the size of the flocs are analysed. If the results are not conclusive, the polymer flocculant is subjected to a shear rate, then the test is repeated.
Fourth, the following steps are carried out: acquisition of data by computer, comparison of the data in order to define the optimal polymer for treating the aqueous effluent to be treated.

The aqueous effluent to be treated is preferably:
an effluent obtained from mining, coming from coal mines, diamond mines, phosphate mines, metal mines such as aluminium, platinum, iron, gold, copper, silver mines; or
an effluent obtained from mining of bituminous sand or oil sand; or
an effluent comprising solid particles; or
an effluent comprising sand, clay and water; or
an effluent comprising sand, clay, water and residual bitumen; or
an effluent comprising fresh tailings; or
an effluent comprising fine tailings; or
an effluent comprising fresh fine tailings (FFT); or
an effluent comprising mature fine tailings (MFT).

The aqueous effluent to be treated is preferably an effluent obtained from mining of bituminous sand or oil sand.

### Detailed Description of FIGS. 1 to 4

FIG. 1 is a graphical depiction of an embodiment of the method of the invention in which a flocculant polymer (P) in powder form is dissolved successively in a rapid dissolution device such as the Floquip PSU, then in maturation tanks to obtain an aqueous solution of flocculant polymer (P). This corresponds to step a) of the method.

According to step b), the solution (S) is separated into two fractions, then each of these fractions is sheared differently. The first fraction passes through a single pump (Apparatus 1) for intensive shearing (γ1) to obtain a solution (S′₁) of flocculant polymer (P′₁) of molecular weight M_{w1}, the second fraction passes through a pump (Apparatus 2) for less intensive shearing (γ2) to obtain a solution (S′₂) of flocculant polymer (P′₂) of molecular weight M_{w2}. The solutions (S′₁) and (S′₂) are then mixed at a predetermined optimum ratio to form a single same solution containing two populations of polymers of different molecular weights (M_{w2}>M_{w1}). The mixture is added to a duct conveying the aqueous effluent to be treated to flocculate same and thus separate the particles in suspension in the water.

FIG. 2 is a graphical depiction of an embodiment of the method of the invention in which a solution (S) of flocculant polymer (P) is obtained in the same way as in FIG. 1. According to step b), the solution (S) is separated into two fractions, the first fraction of the aqueous solution (S) circulates in at least two shearing apparatus (Apparatus 3) installed in series, in order to subject the water-soluble polymer (P) present in the solution to sufficient shearing (2*γ3) to attain the desired properties. A solution (S′₁) of flocculant polymer (P′₁) of molecular weight M_{w1} is obtained. The second fraction circulates in a single shearing apparatus (Apparatus 3, shearing γ3) to obtain a solution (S′₂) of flocculant polymer (P′₂) of molecular weight M_{w2}.

Next, in the same way as in FIG. 1, the flows of solutions (S′₁) and (S′₂) are mixed in a suitable proportion, then the mixture is added to a duct conveying the aqueous effluent to be treated.

FIG. 3 is a graphical depiction of an embodiment of the method of the invention in which a solution (S) of flocculant polymer (P) is obtained in the same way as in FIG. 1. According to step b), several successive shearings are applied to the first fraction of aqueous solution (S) by recirculating all or part of the sheared solution in the same shearing apparatus (Apparatus 4), in order to subject the water-soluble polymer (P) present in the solution to sufficient shearing to attain the desired properties. A solution (S′₁) of flocculant polymer (P′₁) of molecular weight M_{w1} is obtained. The second fraction circulates in a single shearing apparatus (Apparatus 4) to obtain a solution (S′₂) of flocculant polymer (P′₂) of molecular weight M_{w2}. Next, in the same way as in FIG. 1, the flows of solutions (S′₁) and (S′₂) are mixed in a suitable proportion, then the mixture is added to a duct conveying the aqueous effluent to be treated.

FIG. 4 is a graphical depiction of an embodiment of the method of the invention in which part of the solution of water-soluble polymer (P) circulates in an intensive shearing apparatus (Apparatus 1, shearing γ1) to obtain a solution (S′₁) of flocculant polymer (P′₁) of molecular weight M_{w1}, and another part of the solution of water-soluble polymer (P) circulates in a less intensive shearing apparatus (Apparatus 2, shearing γ2) to obtain a solution (S′₂) of flocculant polymer (P′₂) of molecular weight M_{w2}. The aqueous solutions (S′₁) and (S′₂) are added to the aqueous effluent to be treated separately and independently of one another.

### EXAMPLES

The following examples illustrate the advantages of the invention, clearly and in a non-limiting manner.

### Example 1: Preparation of a Water-Soluble Polymer (P1)

A water-soluble polymer designated (P1) is prepared according to the method below. The designation (P1) in the Examples section means that this is the first polymer tested, and does not correspond to the index n used in the description to define the number of polymers obtained after step b) of mechanical treatment. The same applies to the solution (S1).

In a 3 litre beaker equipped with a mechanical stirrer and a thermometer, 1050 g of deionized water, 268.52 g of acrylamide (60 mol %) and 181.48 g of acrylic acid (40 mol %) are added. The mixture obtained is homogenized and neutralized with sodium hydroxide until a pH equal to 7.6-7.7 is obtained. The mixture is then transferred to an adiabatic reactor equipped with a nitrogen intake, and is then cooled to 0° C. before finally being degassed under a nitrogen flow for 30 min. Polymerization is then initiated with the aid of a redox system (tert-butyl hydroperoxide/Mohr's salt). The resulting gel obtained after polymerization is then ground and dried in a drying oven to obtain a powder. Table 1 summarizes the properties of the polymer (P1).

TABLE 1
Properties of the polymer (P1)

| Polymer | Anionicity | UL Viscosity |
|---|---|---|
| P1 | 40 mol % | 6.5 cP |

### Example 2: Obtaining a Range of Solutions of Polymers of Different Molecular Weights from the Polymer (P1)

A solution (S1) of polymer (P1) is obtained by dissolving 0.45% by weight of polymer (P1) in water. Part of the solution (S1) is drawn off prior to the first shearing cycle. The rest of the solution (S1) is subjected to successive shearings.

A shearing cycle corresponds to a passage through a shearing pump in which the liquid passes through a pipe having an inside diameter of 10.8 cm to a pipe having a smaller diameter (0.87 mm) under a pressure of 60 bar. After each shearing cycle, part of the sheared solution is drawn off prior to carrying out an additional shearing cycle on the remainder. A solution (S1) and six solutions of polymers, sheared in the successive shearing cycles, are thus obtained.

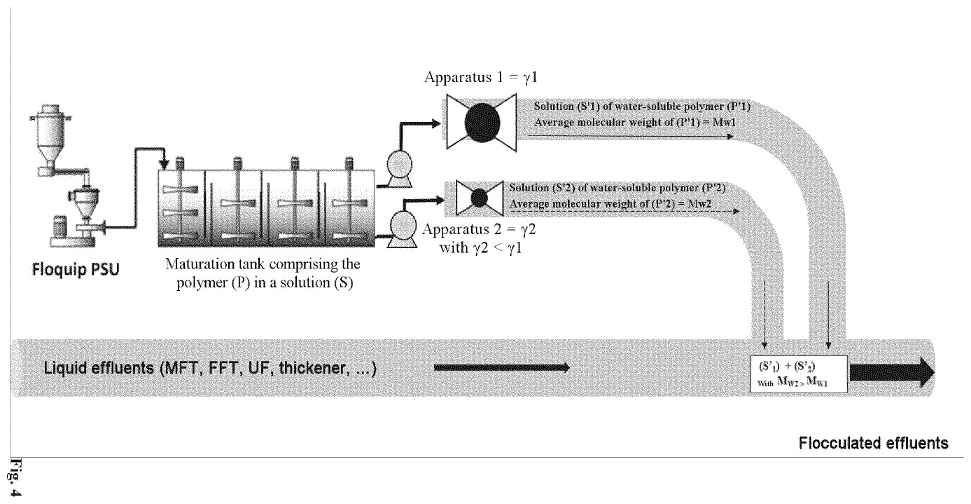

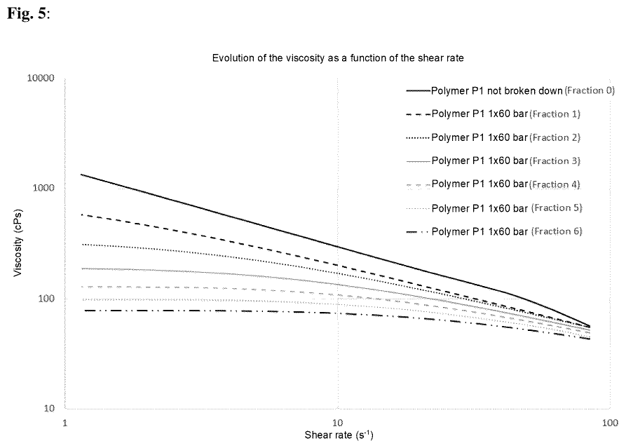

The rheological profiles of the solution (S1) and of the six fractions obtained after the polymer (P1) is degraded (broken down) by shearing at 60 bars are presented in FIG. 5. The viscosity of the solution containing the polymer (P1) falls after each degradation cycle, reflecting the reduction in the average molecular weight of the polymer (P1) in the solution (S1).

### Example 3: Practical Examples

### Tests on Site

The polymer (P1) was used at an interval of two months on two samples of effluent taken at two different times on the same site.

One was sampled in the month M (effluent with 7.68% solids by weight) and the second in the month M+2 (effluent with 4.75% solids by weight).

Shear degradation of the solution (S1) containing:
2 litres of a solution at 0.45% by weight of (P1) were prepared with synthetic water.
Degradation by shearing with the aid of a shear pump. The test device of the shear pump consisted of a pressurized cell connected to a pipe of small diameter. The sample was sheared as it passed through a pipe having an inside diameter of 0.87 mm with a pressure drop set at 60 bar.

After each degradation cycle, 200 mL of sheared solution were collected and kept in a beaker for subsequent analysis.

Six degradation cycles were performed in total, making it possible to obtain six fractions of different molecular weight with a decreasing molecular weight. The name of a fraction corresponds to the number of degradation cycles to which this fraction was subjected. For example, “Fraction 0” corresponds to the non-sheared polymer (P1), “Fraction 1” was subjected to one degradation cycle, while five degradation cycles were applied to “Fraction 5”.

The rheological profiles of the sheared solutions were prepared with the aid of an MCR 302 Kinexus rheometer with cone-plate geometry at 2° and 60 mm at shear rates ranging from 1 to 100 s-1 and at 25° C.
Test for month (M):

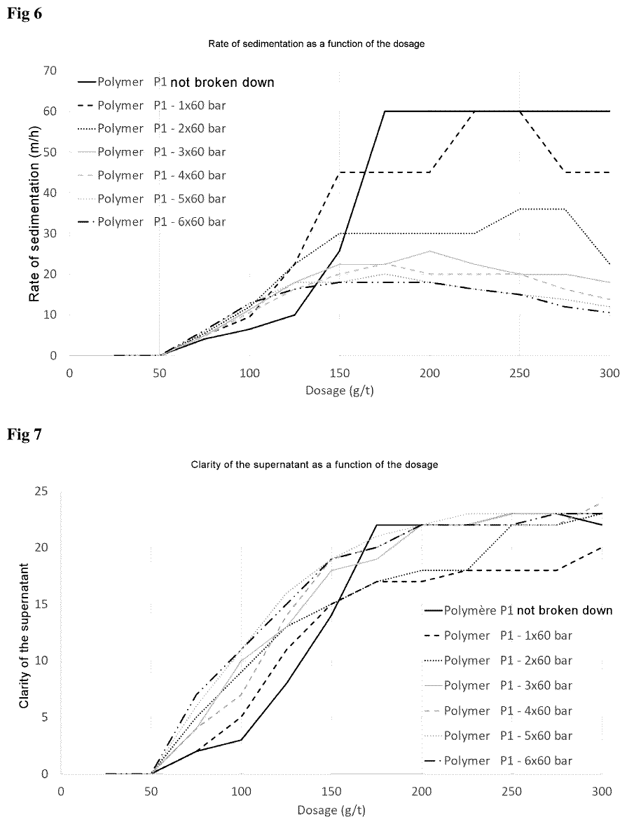

FIG. 6 shows the rates of decantation and FIG. 7 the clarity of the supernatant (clarifications OF) obtained upon flocculation with the water-soluble polymer (P1) and with the seven fractions obtained previously and presented in FIG. 5. Fraction 1 had the fastest rate of sedimentation, followed by Fraction 0, in other words the non-sheared polymer (P1) (FIG. 6).

The applicant found that the rate of sedimentation decreases with the molecular weight. Fractions 5 and 6 have the slowest rates of sedimentation. Conversely, Fractions 5 and 6 yield the best clarification OF, which decreases as the molecular weight increases (FIG. 7). The non-sheared polymer (P1) and Fraction 1 had the poorest quality clarification OF.

The data in FIGS. 6 and 7 show that it is not possible to aim for the best clarity possible OF while maintaining the rate of sedimentation.

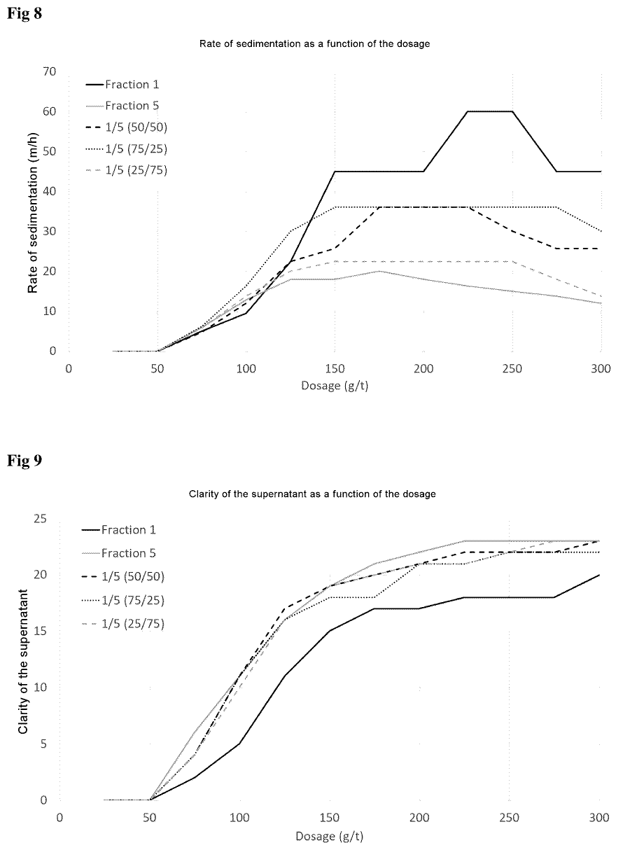

Mixtures of Fractions 1 and 5 were tested and the results are presented in FIGS. 8 and 9.

The data show that a mixture composed of 75% by weight of Fraction 1 and 25% by weight of Fraction 5 made it possible to combine the clarity OF obtained with Fraction 5 while maintaining rapid decantation rates.

The method according to the invention thus makes it possible to achieve superior and optimum effluent flocculation performance.
Month M+2month

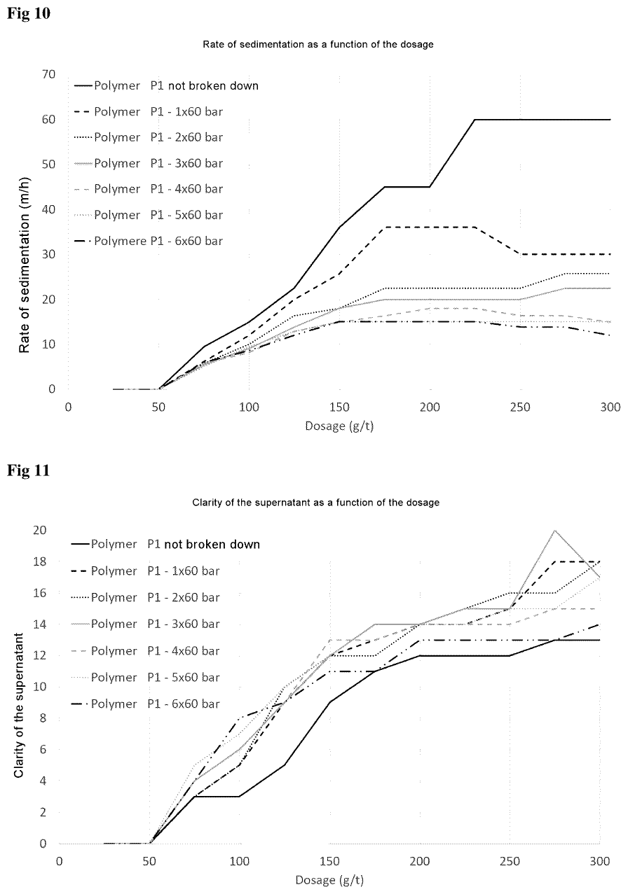

FIG. 10 shows the decantation rates and FIG. 11 the clarification OF obtained upon flocculation of this sample with the seven fractions obtained previously and presented in FIG. 5; Fraction 0 had the fastest decantation rate, followed by Fraction 1 (FIG. 10).

The trends observed are similar to those reported in the test for month M.

Fractions 5 and 6 have the slowest decantation rates but the best clarification OF, which tends to decrease when the molecular weight increases (FIG. 11).

The non-sheared polymer (P1) has the worst OF quality.

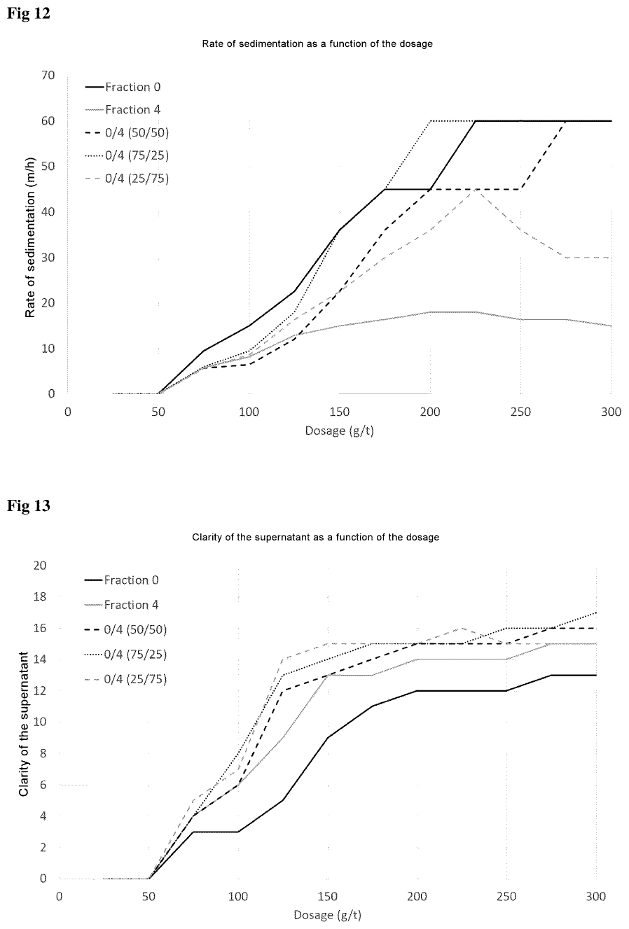

Mixtures of Fractions 0 and 4 were tested and the results are presented in FIGS. 12 and 13.

As the data show, a mixture made up of 75% by weight of Fraction 0 and 25% by weight of Fraction 4 made it possible to combine good clarity OF and rapid decantation rates.

The method according to the invention thus makes it possible to achieve superior and optimum effluent flocculation performance.

1-14. (canceled)

15. A method for treating an aqueous effluent comprising the following steps:
a) preparing an aqueous solution (S) comprising at least one water-soluble polymer (P);
b) mechanical treatment of the solution (S) to form n solutions (S′_{[1, . . . , n]}) respectively comprising at least one water-soluble polymer (P′_{[1, . . . , n]}) resulting from the mechanical treatment of the water-soluble polymer (P);
c) adding to an aqueous effluent:
c1) either at least two of the n solutions (S′_{[1, . . . , n]}), with n being an integer greater than or equal to 2,
c2) or at least one of the n solutions (S′_{[1, . . . , n]}) and the solution (S), with n 5 being an integer greater than or equal to 1.

16. The method according to claim 15, wherein in step c), said preceding solutions (S′_{[1, . . . , n]}) and/or (S) are added to the aqueous effluent separately and independently of one another, or are mixed beforehand prior to being added to the aqueous effluent.

17. The method according to claim 15, wherein step b) of mechanical treatment of the solution (S) comprises the following successive steps:
b1) separation of the solution (S) into n solutions (S_{[1, . . . , n]}), then
b2) shearing of the n solutions (S_{[1, . . . , n]}), in which the n solutions (S_{[1, . . . , n]}) are sheared independently of one another, to form n solutions (S′_{[1, . . . , n]}) respectively comprising at least one water-soluble polymer (P′_{[1, . . . , n]}).

18. The method according to claim 15, wherein step b) of mechanical treatment of the solution (S) comprises the following successive steps:
b1′) shearing of the solution (S), to form a solution (S′_{[1, . . . , n]}) respectively comprising at least one water-soluble polymer (P′_{[1, . . . , n]}), then
b2′) removing at least part of the solution (S′_{[1, . . . , n]}),
then if n is an integer greater than or equal to 2,
b3′) repeating, as many times as necessary, successive steps consisting in shearing the remainder, then in removing at least part thereof, to respectively obtain the solutions (S′_{[2, . . . , n]}).

19. The method according to claim 15 comprising, prior to step a), the following successive steps:
performing flocculation tests, by taking at least one sample of the aqueous effluent to be treated,
determining the combination of water-soluble polymers necessary for treating the aqueous effluent and determining the shear rates to be applied to arrive at this combination.

20. The method according to claim 15, wherein the water-soluble polymer (P) has a UL viscosity of between 3 and 9 cP.

21. The method according to claim 17, wherein shearing is induced by at least one pressurized shearing pump.

22. The method according to claim 15, wherein the average concentration of polymer in the aqueous solutions (S) and (S′ₙ) added to the effluent to be treated relative to the quantity of effluent is between 1 ppm and 15000 ppm.

23. The method according to claim 15, wherein step a) of preparing an aqueous solution (S) of water-soluble polymer (P) is performed using a device for hydration of the solid particles of water-soluble polymer (P), then using one or more tanks for dissolution and for maturation with stirring.

24. The method according to claim 15, wherein the solution (S) comprises between 0.1% and 5% by weight of water-soluble polymer (P) relative to the total weight of the solution (S).

25. The method according to claim 15, wherein the aqueous solutions (S) and (S′ₙ) are added to the effluent in a thickener and/or while said effluent is being conveyed to a deposition zone.

26. The method according to claim 15, wherein the aqueous solutions (S) and (S′ₙ) are added in a pipe conveying said effluent into a thickener and/or while said effluent is being conveyed to a deposition zone.

27. The method according to claim 15, wherein the effluent is:
an effluent obtained from mining, coming from coal mines, diamond mines, phosphate mines, metal mines such as aluminium, platinum, iron, gold, copper, silver mines; or
an effluent obtained from mining of bituminous sand or oil sand; or
an effluent comprising solid particles; or
an effluent comprising sand, clay and water; or
an effluent comprising sand, clay, water and residual bitumen; or
an effluent comprising fresh tailings; or
an effluent comprising fine tailings; or
an effluent comprising fresh fine tailings (FFT); or
an effluent comprising mature fine tailings (MFT).

28. The method according to claim 15, wherein the effluent to be treated is an effluent obtained from mining of bituminous sand or oil sand.
